(19) United States
(12) Patent Application Publication
(10) Pub. No.: US 2010/0099002 A1
(43) Pub. Date: Apr. 22, 2010

(54) FLUID PUMP WITH AN INTEGRATED MOUNTING INTERFACE

(75) Inventors: Benno Andreas-Schott, Bodenheim (DE); Thomas P. Migliore, Rochester, NY (US); Joseph D. Rainville, Caledonia, NY (US)

Correspondence Address: FRASER CLEMENS MARTIN & MILLER LLC, 28366 KENSINGTON LANE, PERRYSBURG, OH, 43551-4163, US

(73) Assignee: GM GLOBAL TECHNOLOGY OPERATIONS, INC., Detroit, MI (US)

(21) Appl. No.: 12/254,891

(22) Filed: Oct. 21, 2008

(51) Int. Cl. H01M 2/00; F16K 35/00; F04B 53/00

(52) U.S. Cl. 429/34; 137/383; 417/313

(57) ABSTRACT

A fluid pump assembly for a fuel cell system is disclosed, the fluid pump assembly including a mounting structure having a receiving element formed thereon and a fluid pump having at least one locking element formed thereon, wherein the mounting structure is a lower end unit of the fuel cell system, and wherein the receiving element captures the locking elements of the fluid pump to militate against lateral, axial, and rotational movement of the fluid pump.

### FIELD OF THE INVENTION

The present disclosure relates to a fluid pump assembly and, more particularly, to a fuel cell system including the fluid pump assembly.

### BACKGROUND OF THE INVENTION

A fuel cell has been proposed as a clean, efficient and environmentally responsible energy source for various applications. Individual fuel cells can be stacked together in series to form a fuel cell stack. The fuel cell stack is capable of supplying a quantity of electricity sufficient to provide power to an electric vehicle. In particular, the fuel cell stack has been identified as a desirable alternative for the traditional internal-combustion engine used in modern vehicles.

One type of fuel cell stack is known as a proton exchange membrane (PEM) fuel cell stack. The typical PEM fuel cell includes three basic components: a cathode, an anode, and an electrolyte membrane. The cathode and anode typically include a finely divided catalyst, such as platinum, supported on carbon particles and mixed with an ionomer. The electrolyte membrane is sandwiched between the cathode and the anode. Porous diffusion media which facilitate a delivery and distribution of reactants, such as hydrogen gas and air, may be disposed adjacent the anode and the cathode.

In a vehicle power system employing the PEM fuel cell stack, the hydrogen gas is supplied to the anodes from a hydrogen storage source, such as a pressurized hydrogen tank. The air is supplied to the cathodes by an air compressor unit. The hydrogen gas reacts electrochemically in the presence of the anode to produce electrons and protons. The electrons are conducted from the anode to the cathode through an electrical circuit disposed therebetween. The protons pass through the electrolyte membrane to the cathode where oxygen from the air reacts electrochemically to produce oxygen anions. The oxygen anions react with the protons to form water as a reaction product.

The electrochemical fuel cell reaction also has a known temperature range within which the reaction may efficiently occur. The electrochemical fuel cell reaction is exothermic and generally allows the fuel cell stack to maintain a temperature within the desired temperature range during an operation thereof. Supplemental heating is typically employed during a start-up operation of the fuel cell stack to raise the temperature of the fuel cell stack within the desired temperature range. For example, the fuel cell stack may be in fluid communication with a coolant system that circulates a coolant through the fuel cell stack. The coolant may be heated, such as with electrical heaters, to raise the temperature of the fuel cell stack. The coolant may also transfer excess heat away from the fuel cell stack by circulating through a radiator that exhausts the heat to the ambient atmosphere.

It is known to circulate the coolant through the fuel cell stack using a fluid pump. Typically, known fluid pumps are produced from a metal material and require the use of additional components, equipment, and tools for installation. The additional components, equipment, and tools are excessively heavy and the fluid pump is susceptible to improper installation.

Accordingly, it would be desirable to produce a fluid pump for a fuel cell stack, wherein the fluid pump is economical to produce and the complexity of production and use thereof is minimized.

### SUMMARY OF THE INVENTION

In concordance and agreement with the present invention a fluid pump for a fuel cell stack, wherein the fluid pump is economical to produce and the complexity of production and use thereof is minimized, has surprisingly been discovered.

In one embodiment, the fluid pump assembly comprises: a mounting structure having a receiving element formed thereon; and a fluid pump having a housing including at least one locking element formed thereon adapted to cooperate with the receiving element of the mounting structure to form a twist lock connection.

In another embodiment, the fluid pump assembly comprises: a mounting structure including a receiving element formed thereon, the receiving element having at least one notch formed therein and a shoulder formed thereon, wherein the shoulder of the receiving element cooperates with a portion of the mounting structure to form a channel therebetween; and a fluid pump including a housing having at least one locking element formed thereon, the at least one locking element adapted to be received in the channel of the mounting structure, wherein the fluid pump is adapted to cooperate with the mounting structure to form a twist lock connection.

In another embodiment, the fuel cell system comprises: a fuel cell stack including at least one fuel cell; a lower end unit disposed adjacent the fuel cell stack, the lower end unit including a receiving element formed thereon, the receiving element having at least one notch formed therein and a shoulder formed thereon, wherein a channel is formed between the shoulder of the receiving element and a portion of the lower end unit; and a fluid pump including a housing having at least one locking element formed thereon, the at least one locking element adapted to be received in the channel of the lower end unit, wherein the fluid pump is adapted to cooperate with the lower end unit to form a twist lock connection.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a partially exploded perspective view showing a fluid pump assembly according to an embodiment of the invention;

FIG. 2 is a partially exploded perspective view, partially in section, of the fluid pump assembly illustrated in FIG. 1;

FIG. 3 is a perspective view, partially in section, of the fluid pump assembly illustrated in FIGS. 1 and 2 assembled with a mounting structure;

FIG. 4 is a partially exploded perspective view of a fluid pump assembly including at least one locking mechanism;

FIG. 5 is a perspective view, partially in section, of the fluid pump assembly illustrated in FIG. 4 assembled with a mounting structure,

FIG. 6 is a partially exploded perspective view of a fluid pump assembly including at least one alternative locking mechanism;

FIG. 7 is a perspective view, partially in section, of the fluid pump assembly illustrated in FIG. 6 assembled with a mounting structure; and

FIG. 8 is a fragmentary perspective view of a fuel cell stack including the fluid pump assembly illustrated in FIG. 1.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

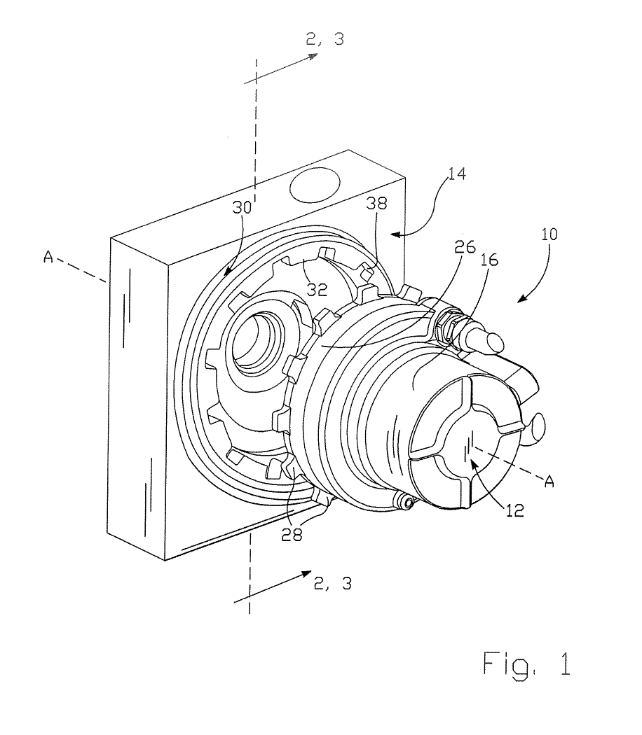

FIG. 1 illustrates a fluid pump assembly 10 according to an embodiment of the invention. The fluid pump assembly 10 includes a fluid pump 12 and a corresponding mounting structure 14. It is understood that the fluid pump 12 can be any type of fluid pump as desired such as a flexible impeller pump, a piston pump, a rotary vane pump, and the like, for example. The fluid pump 12 is adapted to cooperate with the mounting structure 14 and rotate about an axis A from a first position to a second position. The second position is also referred to as a locked position as shown in FIG. 3, to form a twist lock connection. It is understood that the fluid pump 12 can be rotated in a clockwise or a counter clockwise direction about the axis A using a manual or an automatic means, for example.

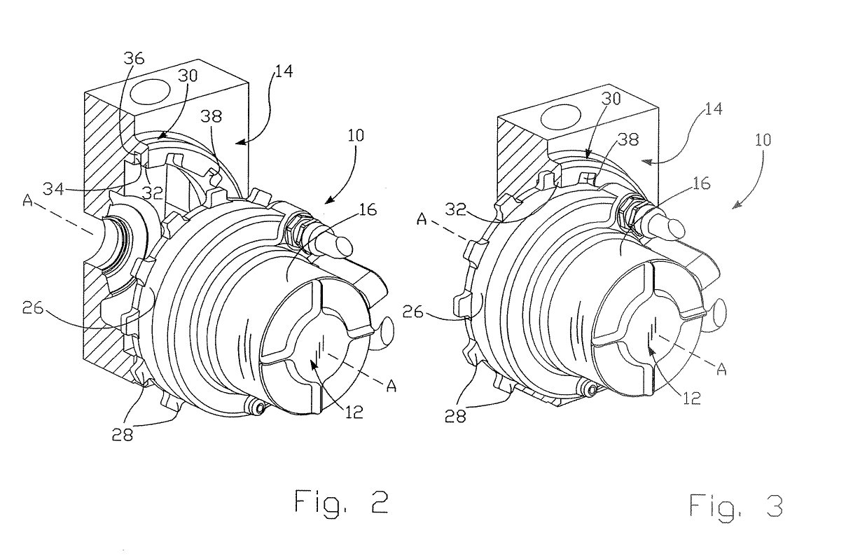

Referring now to FIG. 2, the fluid pump 12 includes a substantially cylindrical housing 16. Although the housing 16 shown is integrally formed as a unitary structure, it is understood that the housing 16 can be separately formed as desired. It is further understood that the fluid pump 12 can have any shape and size as desired. In the embodiment shown, the housing 16 is produced from a non-conductive material to maximize electrical insulation properties of the fluid pump 12. The non-conductive material further militates against a conduction of electricity from the mounting structure 14 to the fluid pump 12 and from internal workings of the fluid pump 12 to an external source (not shown). It is understood that the housing 16 can be produced from any conventional material as desired such as a plastic, for example, and by any conventional method as desired such as an injection molding process, for example.

The housing 16 includes a substantially closed first end and a substantially open second end. In the embodiment shown, the second end of the housing 16 is adapted to be received in the mounting structure 14 and includes a flange 26 extending radially outwardly therefrom. The flange 26 is adapted to cooperate with the mounting structure 14 to form a substantially fluid-tight seal therebetween. An outer periphery of the flange 26 includes an annular array of locking elements 28 formed to extend radially outwardly therefrom. Additional or fewer locking elements 28 can be formed on the flange 26 as desired. Although the locking elements 28 shown are tabs, it is understood that the locking elements 28 can be ribs, teeth, and detents, for example, as desired. As illustrated, the locking elements 28 are spaced-apart and adapted to be received in the mounting structure 14 to militate against a lateral and an axial movement of the fluid pump 12.

The mounting structure 14 includes a radial receiving element 30 formed thereon. The receiving element 30 extends laterally outwardly from the mounting structure 14. A shoulder 32 of the receiving element 30 and a portion 34 of the mounting structure 14 cooperate to form a channel 36 therebetween. It is understood that the receiving element 30 can have any shape and size as desired. The shoulder 32 includes an annular array of notches 38 formed therein. The notches 38 are adapted to receive the locking elements 28 of the housing 16 and permit the locking elements 28 to ingress to the channel 36.

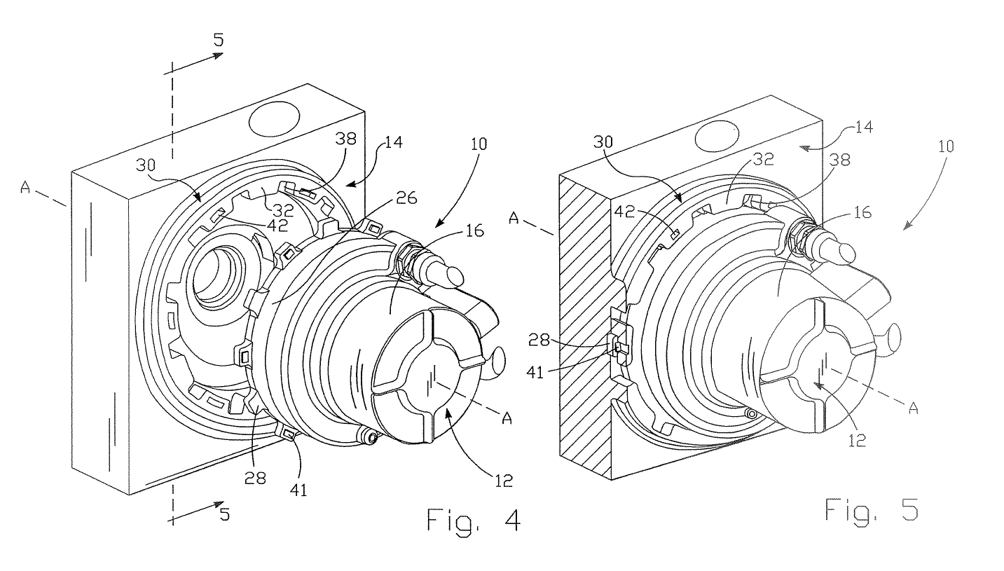

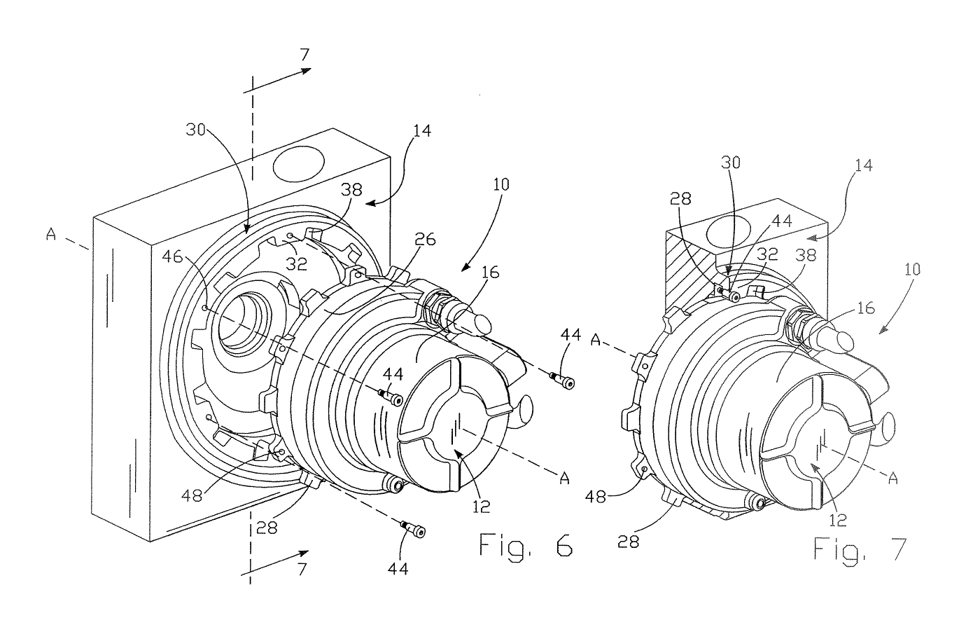

As illustrated in FIGS. 4 to 7, the fluid pump assembly 10 may also include at least one locking mechanism such as a fastener, a snap feature, and the like, for example, to further militate against lateral and rotational movement of the fluid pump 12. As a non-limiting example shown in FIGS. 4 and 5, the locking mechanism includes a detent 41 formed on at least one of the locking elements 28. An aperture 42 formed in the shoulder 32 of at least one of the receiving elements 30 is adapted to receive the detent 41 therein. As another non-limiting example shown in FIGS. 6 and 7, the locking mechanism includes at least one fastener 44. An aperture 46 formed in the shoulder 32 of at least one of the receiving elements 30 substantially aligns with an aperture 48 formed in at least one of the locking elements 28 to receive the fastener 44 therein. As illustrated, the aperture 46 formed in the shoulder 32 of the receiving elements 30 is a threaded opening. It is understood, however, that the aperture 48 formed in the locking elements 28 can also be a threaded opening if desired. It is further understood that fewer or additional locking mechanisms can be used as desired.

The fluid pump assembly 10 may be assembled by positioning the fluid pump 12 relative to the mounting structure 14 thereof, wherein the locking elements 28 of the housing 16 are substantially aligned with the notches 38 formed in the receiving element 30 of the mounting structure 14. The fluid pump 12 is then inserted into the receiving element 30 of the mounting structure 14, thereby causing the locking elements 28 to be disposed in the channel 36. Thereafter, the fluid pump 12 is rotated about the axis A to the locked position as shown in FIG. 3. When the fluid pump 12 is in the locked position, the locking elements 28 are offset with respect to the notches 38. Accordingly, the receiving element 30 captures the locking elements 28, creating a substantially tight interference fit to militate against lateral, axial, and rotational movement of the fluid pump 12 and dislodgement thereof from the mounting structure 14. As shown in FIGS. 4 to 7, the locking mechanism may also be employed to further militate against rotational movement of the fluid pump 12 and dislodgement thereof from the mounting structure 14.

In operation, the fluid pump assembly 10 provides a flow of a fluid for use in a coolant system of a fuel cell stack, for example. It is understood that the fluid pump assembly 10 can be used in other applications as desired without departing from the scope and spirit of the invention. Fluid enters the fluid pump assembly 10, wherein a flow velocity is maintained. Thereafter, the fluid is caused to circulate through the coolant system. It is understood that the fluid can be any fluid such as a refrigerant, a coolant, water, ethylene glycol, and the like, for example.

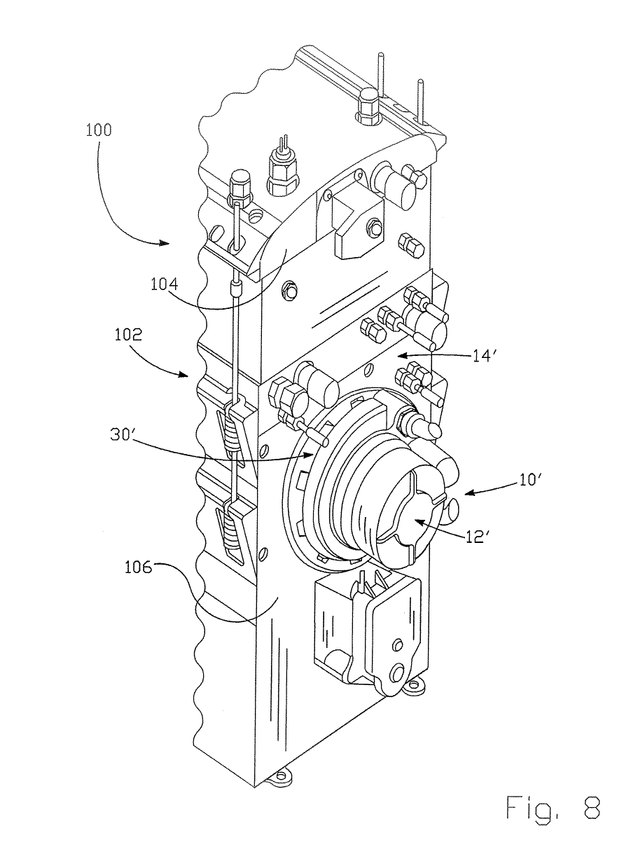

In the embodiment shown in FIG. 8, the present invention further includes a fuel cell system 100 including a fuel cell stack 102 having a fluid pump assembly 10′ disposed thereon. Reference numerals for similar structure in respect of the description of FIGS. 1 to 7 are repeated in FIG. 8 with a prime (′) symbol.

The fuel cell system 100 includes a fuel cell stack 102 disposed between an upper end unit 104 and a lower end unit 106. The upper and lower end units 104, 106 house at least one, and in particular embodiments more than one, fuel cell subsystems and related devices involved in preconditioning and operation of the fuel cell stack 102. As non-limiting examples, the fuel cell subsystems housed within the upper and lower end units 104, 106 can include fluid passages, hydrogen fuel and oxidant (O₂/air) passages, cooling pumps, recirculation pumps, drainage valves, insulation, fans, compressors, valves, electrical connections, reformers, humidifiers, and related instrumentation. It should be recognized that additional fuel cell subsystems and/or peripheral devices used in support of the fuel cell system 100 can also be housed in the upper and lower end units 104, 106 of the disclosure.

In the embodiment shown, the lower end unit 106 of the fuel cell system 100 is integrated with at least one water vapor transport unit, a heat exchanger, and related blowers (not shown), bypass valves (not shown), and a fluid pump assembly 10′. The integration of these and other subsystems into end units 104, 106 contributes to faster cold starts as the systems are heated more quickly due to a proximity to the fuel cell stack 102. Furthermore, integration results in faster re-starts as there is little to no external plumbing running outside of the fuel cell system 100, i.e there is less opportunity for heat energy transfer to occur. The integration of subsystems into the end units also eliminates the need for external housing and plumbing, thereby reducing the overall mass and thermal mass of the system.

As illustrated, the lower end unit 106 is a mounting structure 14′ including a receiving element 30′ formed thereon. The receiving element 30′ is adapted to receive a fluid pump 12′ of the fluid pump assembly 10′. The fluid pump assembly 10′ is in fluid communication with the fuel cell stack 102 and adapted to provide a flow of a fluid thereto. It is understood that the fluid can be any fluid such as a refrigerant, water, and the like, for example. In a non-limiting example, the fluid pump assembly 10′ may be part of a coolant system having, for example, a coolant tank (not shown) for containing the fluid circulating through the coolant system to and from the fuel cell stack 102.

Since the fluid pump assembly 10′ has substantially similar structure as the fluid pump assembly 10, the fluid pump assembly 10′ may be assembled as previously described herein. Additionally, for simplicity, the operation of the fluid pump assembly 10′ is as previously described herein.

From the foregoing description, one ordinary skilled in the art can easily ascertain the essential characteristics of this invention and, without departing from the scope and spirit thereof, can make various changes and modifications to the invention to adapt it to various usages and conditions.

What is claimed is:

1. A fluid pump assembly comprising:
a mounting structure having a receiving element formed thereon; and
a fluid pump having a housing including at least one locking element adapted to cooperate with the receiving element of the mounting structure to form a twist lock connection.

2. The fluid pump assembly according to claim 1, wherein the receiving element of the mounting structure includes a shoulder formed thereon.

3. The fluid pump assembly according to claim 2, wherein a portion of the mounting structure cooperates with the shoulder of the receiving element to form a channel therebetween.

4. The fluid pump assembly according to claim 1, wherein the receiving element includes at least one notch formed therein.

5. The fluid pump assembly according to claim 1, wherein the fluid pump includes at least one locking mechanism.

6. The fluid pump assembly according to claim 5, wherein the at least one locking mechanism is one of a detent formed on the receiving element of the mounting structure adapted to be received in an aperture formed in the at least one locking element, and a fastener adapted to be received in an aperture formed in the receiving element substantially aligned with an aperture formed in the at least one locking element.

7. The fluid pump assembly according to claim 1, wherein the fluid pump and the mounting structure form a substantially fluid-tight seal therebetween.

8. The fluid pump assembly according to claim 1, wherein the mounting structure is a lower end unit of a fuel cell system.

9. The fluid pump assembly according to claim 1, wherein the housing of the fluid pump is produced from a non-conductive material.

10. A fluid pump assembly comprising:
a mounting structure including a receiving element formed thereon, the receiving element having at least one notch formed therein and a shoulder formed thereon, wherein the shoulder of the receiving element cooperates with a portion of the mounting structure to form a channel therebetween; and
a fluid pump including a housing having at least one locking element formed thereon, the at least one locking element adapted to be received in the channel of the mounting structure, wherein the fluid pump is adapted to cooperate with the mounting structure to form a twist lock connection.

11. The fluid pump assembly according to claim 10, wherein the fluid pump includes at least one locking mechanism.

12. The fluid pump assembly according to claim 11, wherein the at least one locking mechanism is one of a detent formed on the shoulder of the receiving element adapted to be received in an aperture formed in the at least one locking element, and a fastener adapted to be received in an aperture formed in the receiving element substantially aligned with an aperture formed in the at least one locking element.

13. The fluid pump assembly according to claim 10, wherein the housing and the mounting structure form a substantially fluid-tight seal therebetween.

14. The fluid pump assembly according to claim 10, wherein the mounting structure is a lower end unit of a fuel cell system.

15. The fluid pump assembly according to claim 10, wherein the housing of the fluid pump is produced from a non-conductive material.

16. A fuel cell system comprising:
a fuel cell stack including at least one fuel cell;
a lower end unit disposed adjacent the fuel cell stack, the lower end unit including a receiving element formed thereon, the receiving element having at least one notch formed therein and a shoulder formed thereon, wherein a channel is formed between the shoulder of the receiving element and a portion of the lower end unit; and
a fluid pump including a housing having at least one locking element formed thereon, the at least one locking element adapted to be received in the channel of the lower end unit, wherein the fluid pump is adapted to cooperate with the lower end unit to form a twist lock connection.

17. The fuel cell system according to claim 16, wherein the fluid pump includes at least one locking mechanism.

18. The fuel cell system according to claim 17, wherein the at least one locking mechanism is one of a detent formed on the shoulder of the receiving element adapted to be received in an aperture formed in the at least one locking element, and a fastener adapted to be received in an aperture formed in the receiving element substantially aligned with an aperture formed in the at least one locking element.

19. The fuel cell system according to claim 16, wherein the housing and the lower end unit form a substantially fluid-tight seal therebetween.

20. The fuel cell system according to claim 16, wherein the housing of the fluid pump is produced from a non-conductive material.
